(19) United States
(12) Patent Application Publication
(10) Pub. No.: US 2007/0108830 A1
(43) Pub. Date: May 17, 2007

(54) DOOR ARMREST SYSTEM WITH PULL CUP

(75) Inventors: Carl James Hessler, Ypsilanti, MI (US); Timothy John Mooney, Grosse Ile, MI (US); Charles E. Roe, Washington, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 11/164,182

(22) Filed: Nov. 14, 2005

(51) Int. Cl. B60N 3/02

(52) U.S. Cl. 297/411.21

(57) ABSTRACT

An armrest system provided for a door trim panel assembly in a vehicle. The armrest system has an inner skin that containing an energy-absorbing material that cushions forces associated with side impact. A substrate is situated at least partially around the energy-absorbing material so that the energy-absorbing material is contained between the inner skin and the substrate. A cup is detachably attached to the substrate. Forming the cup is a base with a pair of lateral edges and a pair of longitudinal edges. A longitudinal wall extends from one of the longitudinal edges. A pair of lateral walls extends from the pair of lateral edges. A tether girds the pair of lateral walls and the longitudinal wall.

### BACKGROUND OF THE INVENTION

1. Field of the Invention

The invention relates to an armrest that extends from a door trim panel in a vehicle. More specifically, the invention includes an armrest that deforms to absorb forces associated with side impacts, yet exhibits strength and rigidity in response to pulling forces exerted by an in-vehicle occupant who wishes to close an open door.

2. Background Art

Most doors in automobiles have a stiff frame that supports an inner trim panel. Often, that panel includes an armrest. The armrest supports the arm of a driver or passenger and the weight of the occupant if he or she leans on the armrest, perhaps with an elbow.

The armrest is ideally designed to absorb forces generated by side impact, while being soft enough to cushion a sideways blow to minimize injury to the vehicle occupant.

In some vehicles, the armrest also includes a recess or cup which may be gripped by an occupant's hand in order to close an open door. Thus, there is a requirement that an armrest with a pull cup exhibit strength and rigidity when subjected to pulling forces. But when the occupant and armrest interact during a side impact, there is an opposing requirement: low stiffness so that the blow may be cushioned.

Among the art identified in a search that was undertaken before filing this patent application are the following U.S. references: U.S. Pat. Nos. 4,453,760; 4,783,114; 4,919,470; 4,929,017; 5,527,084; 5,884,434; 5,931,682; 5,967,470; and 6,893,077.

### SUMMARY OF THE INVENTION

In one embodiment of the invention, an armrest system is provided for a door trim panel assembly in a vehicle. The armrest system has an inner skin that faces a vehicle occupant. Positioned within the inner skin is an energy-absorbing material that cushions forces associated with side impact. A substrate is situated at least partially around the energy-absorbing material so that the energy-absorbing material is contained between the inner skin and the substrate.

A cup is detachably attached to the substrate. Forming the cup is a base with a pair of lateral edges and a pair of longitudinal edges. A longitudinal wall extends from one of the longitudinal edges. A pair of lateral walls extends from the pair of lateral edges.

To provide support to the cup when it is grasped by a vehicle occupant while closing the vehicle door, a tether girds the pair of lateral walls and the longitudinal wall.

### BRIEF DESCRIPTION OF THE DRAWINGS

FIG. 1 is an isometric view of an armrest system in a door trim panel assembly;

FIG. 2 is a vertical sectional view taken along the line of A-A of FIG. 1; and

FIG. 3 is a horizontal sectional view taken along the line of B-B of FIG. 1.

### DETAILED DESCRIPTION OF THE PREFERRED EMBODIMENT(S)

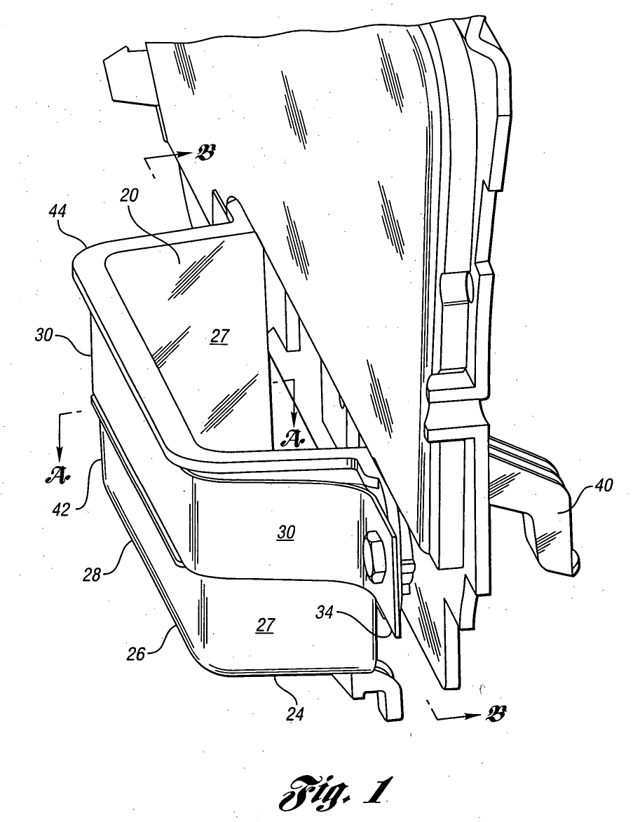

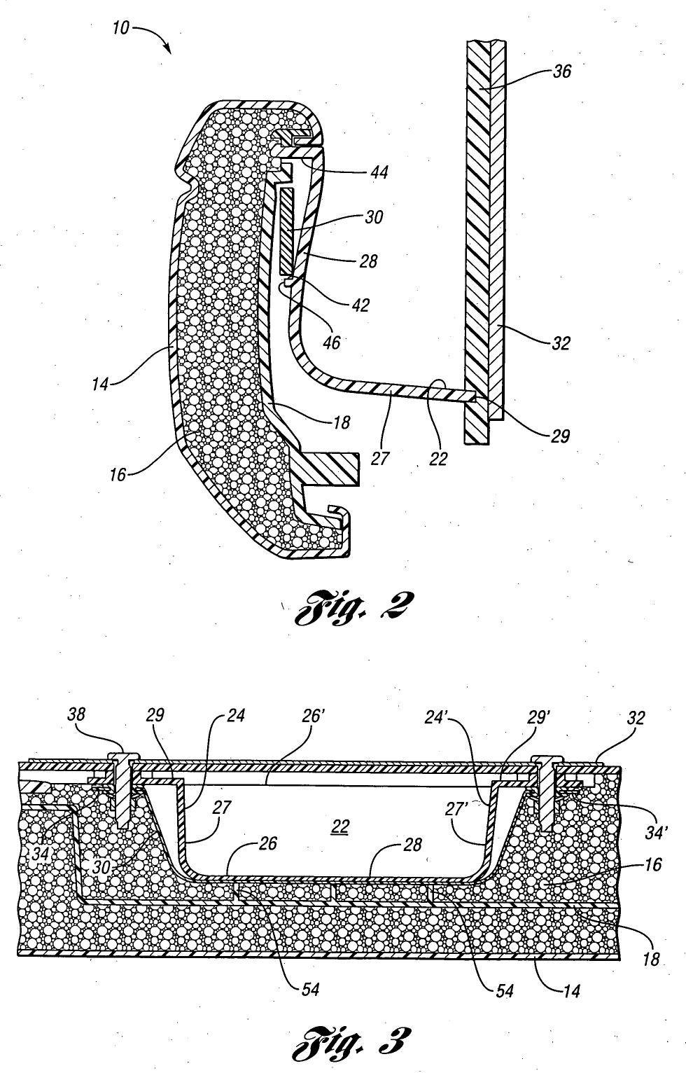

FIGS. 1-3 of the drawings depict an armrest system 10 that is located in a door trim panel assembly for a vehicle. The armrest system 10 has an inner skin 14 (FIG. 2) that faces a vehicle occupant (not shown). Positioned within the inner skin 14 is an energy-absorbing material, such as foam 16. The energy-absorbing material 16 absorbs energy during a side impact, as does the armrest skin, the armrest substrate, and a cup, thereby serving to protect the vehicle occupant.

Turning with particular reference to FIG. 2, a substrate 18 is situated at least partially around the energy-absorbing material 16 so that the latter is contained between the inner skin 14 and the substrate 18.

As depicted in FIGS. 1-3, the armrest system 10 includes a cup 20 that is detachable, attached to the substrate 18. Designed to collapse and absorb energy during side impact, the cup can be grasped by a vehicle occupant while closing the vehicle door and thereby subjecting the armrest system 10 to inwardly directed pulling forces. The cup has a base 22 (FIGS. 2-3), which is partially defined by a pair of lateral edges 24,24′ (FIG. 3). Extending between the lateral edges 24, 24′ is a pair of longitudinal edges 26,26′ (FIG. 3). A longitudinal wall 28 extends from one of the longitudinal edges 26. Each lateral wall 24,24′ has an open edge 29,29′ (FIG. 3). Thus, in a preferred embodiment, the cup is defined primarily by its base 22, and three walls: i.e., pair of lateral walls 27,27′ and one longitudinal wall 28 that are preferably joined by curved sections.

In alternate embodiments, the pull cup may be shaped as a part of a hemisphere or one part of a spheroid and more particularly, a prolate spheroid.

To provide support to the cup when it is grasped by a vehicle occupant, a tether 30 girds the pair of lateral walls 27,27′ and the longitudinal wall 28. The tether 30 itself plays little role in energy absorption. Thus, the armrest system 10 provides stiffness in opposing inwardly directed forces exerted by a vehicle occupant who desires to close the vehicle door, yet the overall system 10 offers a cushioning effect when side impact forces are directed inwardly from outside the vehicle.

In an alternate embodiment, a longitudinally extending bracket 32 (FIGS. 2-3) spans the open edges 29,29′ of the lateral walls 27,27′. Preferably, the tether 30 provided with end regions 34,34′ that are secured to the bracket 32. In one embodiment, an outer energy absorbing material 36 (FIG. 2) is provided between the open edges 29 of the lateral walls 27,27′.

As best shown in FIG. 3, the armrest system 10 includes means 38 for securing the tether 30 to the bracket 32. In some embodiments, the means 38 is selected from a group consisting a nut-bolt combination, a rivet, a glue, an adhesive, a weld stud, and combinations thereof.

As best shown in FIG. 1, extending from the bracket is means 40 for attaching the bracket to sheet metal (not shown) associated with the vehicle door. In some embodiments, the means for attaching 40 is selected from the group consisting of a J-shaped member, a nut-bolt combination, a rivet, a weld stud, a screw, a glue, an adhesive, and combinations thereof.

As best illustrated in FIG. 2, the tether 30 is accommodated by a channel 42 that is defined at or in the sides of at least one of the lateral walls 29,29′ and the longitudinal wall 28. Preferably, the channel 42 is located toward an upper area of these walls. As illustrated, the channel 42 is defined at least in part by a lip 44 (FIGS. 1-2) that extends inwardly (in relation to the vehicle interior) from the cup 20 and a rib 42 (FIG. 2).

Turning now to FIG. 2, there is depicted an applique 32 that preferably is a stiff plastic or other material with similar stiffness characteristics. Examples include but are not limited to composites, metals, and metal alloys. Thus, the outer energy absorbing material 36 lies between the applique 32 and the cup 20.

If desired, as shown in FIG. 3, one or more stiffening ribs 54 may extend toward the longitudinal wall 28 from the substrate 18. The stiffening ribs preferably extend laterally in relation to the cup, although they could also extend in a direction that is inclined thereto, especially around the edges of the cup where the lateral and longitudinal walls unite.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. An armrest system in a door trim panel assembly for a vehicle, the armrest system comprising:
an inner skin that faces a vehicle occupant;
an energy-absorbing material positioned within the inner skin to cushion forces associated with side impact;
a substrate situated at least partially around the energy-absorbing material so that the latter is contained between the inner skin and the substrate;
a cup having a base with a pair of lateral edges and a pair of longitudinal edges, a longitudinal wall extending from one of the longitudinal edges, and a pair of lateral walls, each lateral wall having an open edge, the cup being detachably attached to the substrate; and
a tether that girds the pair of lateral walls and the longitudinal wall to provide support to the cup when grasped by a vehicle occupant while closing the vehicle door and thereby subjecting the armrest system to inwardly directed pulling forces, the tether offering minimal resistance to collapse during a side impact.

2. The armrest system of claim 1, further including a longitudinally extending bracket that spans the lateral walls, the tether having end regions that are secured to the bracket.

3. The armrest system of claim 2, further including an outer energy-absorbing material that is provided between the open edges of the pair of lateral walls.

4. The armrest system of claim 3, further including means for securing the tether to the bracket.

5. The armrest system of claim 4, wherein the means for securing is selected from a group consisting of a nut-bolt combination, a rivet, a glue, an adhesive, a weld stud, and combinations thereof.

6. The armrest of claim 5, wherein the bracket includes means for attaching the bracket to sheet metal associated with the vehicle door.

7. The armrest system of claim 6, wherein the means for attaching is selected from the group consisting of a J-shaped member, a nut-bolt combination, a rivet, a weld stud, a screw, a glue, an adhesive, and combinations thereof.

8. The armrest system of claim 1, wherein at least one of the lateral and longitudinal walls define a channel that accommodates the tether.

9. The armrest system of claim 8, wherein the channel is defined at least in part by a lip that extends inwardly from the cup and a rib that also extends therefrom.

10. The armrest system of claim 9, further including an applique that lies outside the outer energy absorbing material so that the outer energy absorbing material lies between the applique and the cup.

11. The armrest system of claim 1, further including one or more stiffening ribs that extend toward the longitudinal wall from the substrate, the stiffening ribs extending laterally in relation to the cup.
